(19) United States
(12) Patent Application Publication
(10) Pub. No.: US 2026/0050890 A1
(43) Pub. Date: Feb. 19, 2026

(54) SYSTEMS AND METHODS FOR RECOGNITION SAVINGS ACCOUNT CREATIONS AND USE

(71) Applicant: MARK DILLON, WEST CHESTER, OH (US)

(72) Inventor: MARK DILLON, WEST CHESTER, OH (US)

(21) Appl. No.: 19/252,618

(22) Filed: Jun. 27, 2025

Related U.S. Application Data
(60) Provisional application No. 63/665,233, filed on Jun. 27, 2024.

(51) Int. Cl. G06Q 10/1057; G06Q 30/0208

(52) U.S. Cl. CPC G06Q 10/1057; G06Q 30/0208

(57) ABSTRACT

The enclosed invention concerns and provides a Recognition Savings Account (RSA) system as part of an employee benefit program. More specifically, an RSA herein includes a) a software component comprising instructions executable by a processor to enable user selection of one or more employee reward categories from a predefined or customizable set; b) a module for selecting employee recognition categories; c) a module for detailing reward types for each recognition and reward category; d) a personalization engine configured to receive structured input data and generate a weighted vector profile that adapts recognition and savings plan parameters to organization-specific factors including size, industry, workforce demographics, and core values, including company values, branding, and employee demographics; e) a module for selecting employee investment options; and f) a machine learning engine comprising one or more supervised learning models (e.g., gradient boosting or neural networks), trained on historical employer and employee data to generate personalized recognition and savings plans based on performance, engagement metrics, and demographic inputs.

### PRIORITY CLAIM

This application claims the benefit of priority under 35 U.S. C. § 119(e) to U.S. Provisional Ser. No. 63/665,233 , entitled “Systems and Methods for Recognition Savings Account Creations and Use,” filed on Jun. 27, 2024, the entire contents of which are hereby incorporated by reference in their entirety.

### FIELD OF THE INVENTION

The enclosed invention concerns and provides a Recognition Savings Account (RSA) system as part of an employee benefit program. More specifically, an RSA herein includes a) a software component comprising instructions executable by a processor to enable user selection of one or more employee reward categories from a predefined or customizable set; b) a module for selecting employee recognition categories; c) a module for detailing reward types for each recognition and reward category; d) a personalization engine configured to receive structured input data and generate a weighted vector profile that adapts recognition and savings plan parameters to organization-specific factors including size, industry, workforce demographics, and core values, including company values, branding, and employee demographics; e) a module for selecting employee investment options; and f) a machine learning engine comprising one or more supervised learning models (e.g., gradient boosting or neural networks), trained on historical employer and employee data to generate personalized recognition and savings plans based on performance, engagement metrics, and demographic inputs.

### SUMMARY OF THE INVENTION

Accordingly, the present invention provides a Recognition Savings Account (RSA) system as part of an organization's employee benefits program. The major components of the RSA are a) a module for selecting employee reward categories; b) a software component comprising instructions executable by a processor to enable user selection of one or more employee reward categories from a predefined or customizable set; c) a module for detailing reward types for each recognition and reward category; d) a personalization module for customizing the program to company-specific details, including company values, branding, and employee demographics; e) a module for selecting employee investment options; and f) a machine learning engine comprising one or more supervised learning models (e.g., gradient boosting or neural networks), trained on historical employer and employee data to generate personalized recognition and savings plans based on performance, engagement metrics, and demographic inputs.

Also, employee reward categories can include each of the following together or in whatever combination desirable by an organization or company a) performance rewards; b) behavioral rewards; c) developmental rewards; and d) tangible and other reward type.

Employee recognition categories include a) company values-based recognition; b) performance-based recognition; c) social-based recognition; d) public-based recognition; and e) nomination-based recognition.

The personalization module may further comprise a) means for incorporating company-specific colors, logos, and program names; and b) a means for including company details such as industry type, number of employees, and organizational priorities.

The system's AI engine herein utilizes input data comprising a) employer baseline data, including attrition rates and lost time; b) employee baseline data, including survey responses, personal savings, and security feelings; and c) RSA-specific data, including recognition activities, spend, and key performance indicators (KPIs).

The system's performance rewards may include a) manager discretionary rewards; b) peer-to-peer rewards; c) customer-based rewards; and d) sales and project-based rewards. Its behavioral rewards include a) social rewards; b) celebration rewards; and c) unique event-based rewards. The system's developmental rewards may include a) learning achievement rewards; b) savings goal attainment rewards; and c) idea and improvement rewards.

The system's tangible rewards may include a) merchandise rewards; b) travel rewards; and c) experiential rewards. The module for detailing reward types may includes all of the follow: a) options for monetary rewards; b) options for tangible rewards; and c) options for a combination of monetary and tangible rewards.

In practice, the system further comprises an output module configured to generate a personalized RSA program design, ready for implementation, with options for self-guided implementation, guided consultation, or custom implementation. The system's AI engine's output may include either one or more recommendations for recognition and reward categories and types and/or one or more recommendations based on business characteristics and employee demographics.

When present, the system's module for selecting employee investment options may include one or more options for different financial institutions and/or one or more options for various investment vehicles tailored to employee preferences. Within the system itself, it may further comprise a collaborative analytics platform enabling employers to share anonymized RSA configuration data, benchmark results, and receive AI-enhanced comparative feedback based on similar organizational profiles.

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1 is a high-level process flow chart showing the step-by-step composition of the Recognition Savings Account (RSA) system, including creation of the account, selection of reward and recognition categories, program personalization, and generation of investment options;

FIG. 2 illustrates the multiple recognition categories available within the RSA system, such as company values-based recognition, performance-based recognition, social recognition, developmental recognition, public-based recognition, and nomination-based recognition. Each category includes customizable types and can be linked to specific triggers or events;

FIG. 3 depicts the various reward categories supported by the system, including recognition rewards, performance rewards, behavioral rewards, social rewards, developmental rewards, and tangible rewards. It also identifies subtypes within each category, such as manager discretionary rewards, peer-to-peer awards, and customer tipping;

FIG. 4 presents the different reward detail types assignable to each recognition or reward category. These include monetary-only rewards, combined cash and tangible item rewards (“Cash Plus”), employer-determined value awards, and choice-driven options involving travel, merchandise, or experiences;

FIG. 5 shows the employer personalization flow, including entry of company-specific data such as logos, colors, priorities, budget, and employee demographics. It further illustrates how this information is processed by the AI engine to generate a customized RSA program;

FIG. 6 details the AI learning inputs and data flow process. It includes employer baseline data (e.g., attrition, absenteeism), employee baseline data (e.g., financial habits, survey responses), and system-collected RSA performance data. These are combined and analyzed by the AI to generate optimized program recommendations;

FIG. 7 is a block diagram illustrating the RSA system architecture, including user device interaction via a user interface layer, network communication with a cloud-hosted backend, and submodules for personalization, AI inference, and data storage. The backend comprises an AI engine, reward database, and investment configuration engine;

FIG. 8 illustrates the AI data pipeline, including data ingestion, preprocessing, feature extraction, model inference, and feedback loop. It demonstrates how supervised and unsupervised learning models are used to refine RSA recommendations based on performance metrics; and

FIG. 9 provides an overview of a generated RSA output structure. It shows how system outputs may be formatted as printable documents, structured datasets (e.g., JSON, XML), or interactive dashboard views, and highlights options for implementation support: self-guided, guided consultation, or custom rollout.

### DETAILED DESCRIPTION OF THE INVENTION

The following description is provided as an enabling teaching of the present systems, and/or methods in its best, currently known aspect. To this end, those skilled in the relevant art will recognize and appreciate that many changes can be made to the various aspects of the present systems, and/or methods described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a”, “an” and “the” include plural referents unless the context clearly dictates otherwise. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can”, “could”, “might”, or “may”, unless specifically stated otherwise, or otherwise understood within the context as used, is generally intended to convey that certain aspects include, while other aspects do not include, certain features, elements and/or steps.

Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed herein are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods.

Thus, if there are a variety of additional steps that can be performed it is understood that each of these additional steps can be performed with any specific aspect or combination of aspects of the disclosed methods.

As used herein, a Recognition Savings Account (RSA) refers to a computer-generated, data-driven program structure delivered to an employer for implementation as an employee benefit. An RSA program comprises a customizable framework for recognizing employee actions, rewarding desired behaviors, and optionally allocating rewards toward long-term savings or investment vehicles. The RSA is generated using employer-provided and employee-specific data processed through a trained machine learning or artificial intelligence (AI) engine. The RSA output includes, but is not limited to, tailored recognition categories, associated reward options, and delivery mechanisms aligned with employer goals and employee preferences.

A recognition module refers to a computing subsystem or software component configured to enable an employer or administrator to define the types of events, behaviors, or values for which employees may be formally recognized within the RSA program. Recognition categories may include company values-based recognition, performance-based recognition, social-based recognition, public-based recognition (including external parties such as customers), and nomination-based recognition. Each category may include predefined options or support the creation of custom recognition types.

A reward module refers to a functional software element that facilitates the selection, organization, and assignment of one or more reward categories within the RSA program. Reward categories may include performance rewards, behavioral rewards, developmental rewards, and tangible rewards. These categories represent distinct reward frameworks targeted at reinforcing different types of employee contributions, such as project completion, consistent attendance, skills development, or goal attainment.

A reward detail module is a component within the RSA system that allows for detailed configuration of the nature and structure of rewards associated with each recognition or reward category. Reward types may include monetary-only rewards (e.g., direct cash bonuses), tangible-only rewards (e.g., merchandise, experiences, travel), or combined monetary and tangible rewards (“Cash Plus”), where a cash value is provided in addition to a tangible benefit. The reward detail module may also support intangible or recognition-only rewards, such as digital badges, public shout-outs, or values-based acknowledgments.

A personalization module refers to a computing engine or software interface that receives and incorporates company-specific data into the RSA generation process. Inputs may include but are not limited to company name, logo, color schemes, industry classification, number of employees, budget constraints, organizational priorities, and preferred program structure. The personalization module interfaces with the AI engine to ensure that all generated RSA components are aligned with the employer's operational, branding, and cultural parameters.

An AI inference engine, as used herein, refers to a trained and trainable software component comprising machine learning models and supporting infrastructure capable of processing structured and unstructured input data to generate customized RSA program recommendations. The AI inference engine may include a data preprocessing module, feature extractor, model inference module, and recommendation generator. It operates in both supervised and unsupervised learning modes, may include feedback and self-training loops, and is configured to improve accuracy over time. Input data may include employer baseline data (e.g., attrition rates, organizational metrics), employee baseline data (e.g., savings habits, engagement scores), and RSA-specific system performance data.

A backend output module refers to the subsystem responsible for formatting and delivering the RSA program in one or more output formats. These may include PDF documents, structured data outputs (e.g., JSON, XML), or live deployment via a dashboard interface. The output module is also responsible for supporting multiple implementation modes, including self-guided deployment by the employer, guided consultation with RSA support services, or fully managed rollout.

A communication interface refers to the data transmission and integration layer within the RSA system. It allows for the secure transfer of RSA outputs and related data to external systems, such as Human Resource Information Systems (HRIS), payroll platforms, or employee-facing mobile/web portals. The communication interface may also support API-based connectivity and employ encryption standards such as TLS/SSL along with access controls including multi-factor authentication.

An investment configuration engine refers to an optional module within the RSA system that enables employers to associate reward outputs with employee-directed financial instruments. This may include integration with savings accounts, 401(k) plans, health savings accounts (HSAs), or external fintech platforms. The module may allow employees to direct certain rewards into designated investment vehicles, either automatically or through employer-configured options.

A community hub refers to a web-based or application-based feature that allows RSA-participating organizations to share program designs, benchmark metrics, and best practices. The hub may include anonymized performance comparisons, forums for employer feedback, and repositories of RSA templates or guides. Although optional, this component facilitates cross-organizational learning and refinement of RSA programs across industries or sectors.

Before the advent of the enclosed invention, the term “recognition savings account” was not a commonly recognized or known term in the financial world. However, the invention comprises a practice within personal finance or organizational management, where contributions—either monetary or in terms of efforts and achievements—are recognized and “saved” or recorded for future reference or reward. This could be used in various contexts, such as employee management, where contributions are noted and rewarded, or in personal goal-setting, where individual achievements are tracked over time.

Artificial intelligence (AI) makes it possible for machines to learn from experience, adjust to new inputs and perform human-like tasks. The AI engine herein is driven by machine learning or a machine learning engine. Artificial intelligence in this invention can be described as the use of a machine learning engine plus intelligent selection of message delivery to a user on his or her mobile device.

Machine learning herein concerns the use and development of computer systems that are able to learn and adapt without following explicit instructions, by using algorithms and statistical models to analyze and draw inferences from patterns in data. Machine learning is a branch of artificial intelligence (AI) and computer science which focuses on the use of data and algorithms to imitate the way that humans learn, gradually improving its accuracy.

Herein, the machine learning engine is an algorithm or a series of algorithms which perform all of the following functions: 1) it redundantly collects employee and employer data; 2) it then forms one or more data sets from the collected location data; 3) it next produces an estimate about a pattern in the data set; 4) it next makes one or more predictions about the one or more data set-i.e., what is likely to happen next as a function of the known data; 5) it rigorously and redundantly evaluates the one or more predictions statistically; and 6) it optimizes the prediction(s) for statistical accuracy and adjusts accordingly where necessary, such adjustments programmable to occur over time.

More specifically, machine learning works in three key ways as follows. First, a decision process occurs in which machine learning algorithms are used to make a prediction or classification. Based on some input data, which can be labelled or unlabeled, your algorithm will produce an estimate about a pattern in the data.

Herein, the term “prediction” refers to the output of an algorithm after it has been trained on a historical dataset and applied to new data when forecasting the likelihood of a particular outcome, such as whether or not an employee will leave with six (6) months. The predictive optimization technology is a universal technology that implements decision making, planning and decisions (i.e., what should be done next) based upon predictions (i.e., what is believed that most likely will happen) by means of artificial intelligence (AI).

Next, an error function is provided that serves to evaluate the prediction of the model. If there are known examples, an error function can make a comparison to assess the accuracy of the model. Last, a model optimization process is provided in which statistical weights are adjusted in the data sets to reduce the discrepancy between a known example and a model estimate. The algorithm repeats this process to evaluate and optimize process, updating weights autonomously until a threshold of accuracy has been met. The greater the accuracy, the greater operator confidence with the results provided by the A/I engine for the RSA system.

Alternatively, the system herein may use deep learning (DL) in addition to or instead of machine learning. The way in which deep learning and machine learning differ relates to how each algorithm learns. Deep learning automates much of the feature extraction piece of the process, eliminating some of the manual human intervention required and enabling the use of larger data sets. Deep learning is referred to as “scalable machine learning”.

Deep machine learning leverages labeled datasets, also known as supervised learning, to inform its algorithm, but it does not necessarily require a labeled dataset. Deep learning based algorithms ingest unstructured data in its raw form (e.g., text, images, sound), and it can automatically determine the set of features which distinguish different categories of data from one another. Unlike machine learning, it does not require human intervention to process data, allowing one to scale machine learning in more interesting ways. Deep learning and neural networks are primarily credited with accelerating progress in areas, such as computer vision, natural language processing, and speech recognition.

Another useful A-I embodiment herein is known as “context aware A-I”. Context aware A“ refers to systems and technologies that can understand, interpret, and respond to contextual information in their environment to improve their performance and user interaction. This means that the A-I system takes into account various factors such as location, time, user preferences, historical interactions, and environmental conditions to make more informed decisions and provide more relevant and personalized responses.

Key features of context-aware A-I include, but are not limited to: a) environmental awareness: understanding the physical and digital environment in which it operates; b) user awareness: recognizing the preferences, behaviors, and needs of the user; c) temporal awareness that takes into account the timing and sequence of events; and d) situational awareness which assesses the specific situation or scenario at hand.

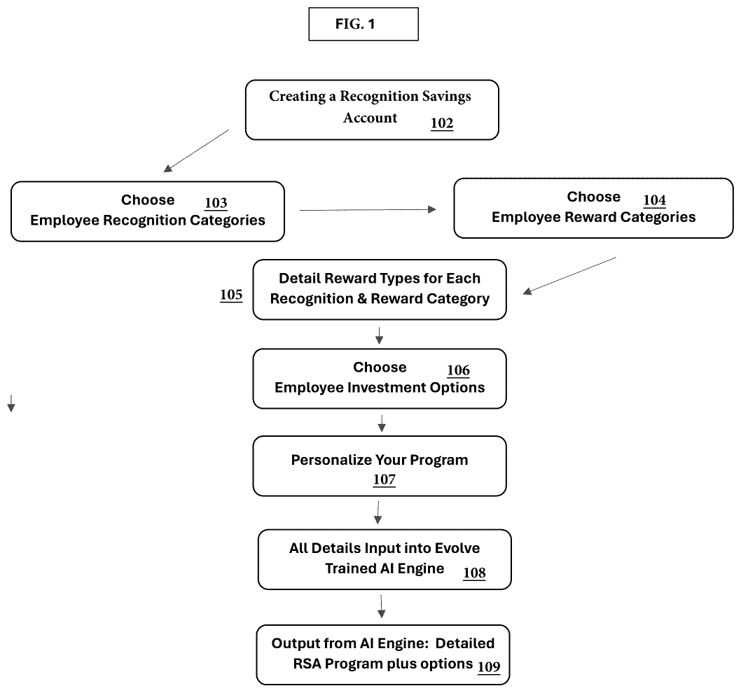

FIG. 1 shows multiple steps of the process for a recognition savings account (RSA) herein. The process involves multiple steps and includes all of the following:

Creating a Recognition Savings Account: This provides many benefits to employees and employers including, but not limited to, reduced financial stress, improved happiness scores at work, less lost time due to financial emergencies, improved attrition, improved productivity, and more.

Choosing Employee Recognition Categories: Categories have been defined to cover all types of job related/employee related recognition from within an organization by peers, management and administration. Recognition is also available in an open model to customers and suppliers related to an organization and also, friends and family of a given employee.

Choose Employee Reward Categories: Categories may be defined by the type of behavior an employer chooses to incentivize (e.g., meeting deadlines, cost cutting, profit increases, innovation and the like). Categories include various types to accommodate many different ways to reward employees. For service based employees there is the option to activate tipping within a customer facing recognition site.

Detail Reward Types for each Recognition and Reward Category: Customize each of the chosen recognition and reward types by a unique reward type. Reward types include recognition, monetary, tangible and intangible reward choices with mixed options for employees to choose from including employer fulfilled reward options.

Program Personalization: Employers may complete an RSA program by providing details related to the company including, but not limited to, industry, firm-a-graphics, demographics, size, budget, and the like.

Evolve AI engine process: utilizing employer data, employee data, industry data, company data, legal/governmental data, Evolve data and more kinds of data, the AI system used herein can create a detailed, dynamic RSA program plan. It is “dynamic” because it can be optimized over time and with new data inputs, and an employer can further develop and tweak the RSA program plan to finalize and further optimize the plan.

Output from AI Engine: A completed RSA plan (or program) is compiled and presented in a format that can be presented either digitally or in printed form. In addition to providing a detailed plan of all types of recognition and rewards, information on additional options is included.

Referring again to FIG. 1, a high-level process diagram is illustrated for generating a Recognition Savings Account (RSA) using a modular, AI-driven configuration platform. The diagram depicts a linear flow of RSA configuration stages and culminates in automated RSA generation through an AI engine.

The process begins at callout 102, labeled “Creating a Recognition Savings Account,” which denotes the initiation of the RSA configuration process. This block represents the starting point for HR administrators or employer representatives accessing the RSA platform.

From the initial creation block 102, the system proceeds to callout 103, labeled “Choose Employee Reward Categories.” In this step, the employer selects one or more overarching categories of employee rewards. These may include performance-based, behavioral, developmental, and tangible rewards, as further defined in subsequent figures and described in the specification. This selection informs downstream customization of the RSA program's motivational logic.

The process continues through 104, labeled “Choose Employee Recognition Categories.” This stage allows the employer to define which recognition categories will be available within the program, including but not limited to company values-based recognition, performance milestones, peer-to-peer acknowledgment, public or customer-facing recognition, and nomination-based frameworks.

At 105, labeled “Detail Reward Types for Each Recognition & Reward Category,” the employer specifies the precise reward types associated with each selected category. This may include monetary-only, tangible-only, and hybrid “Cash Plus” rewards, as well as recognition-only formats. The reward detail logic ensures each recognition event has a mapped output aligned with company culture and budget constraints.

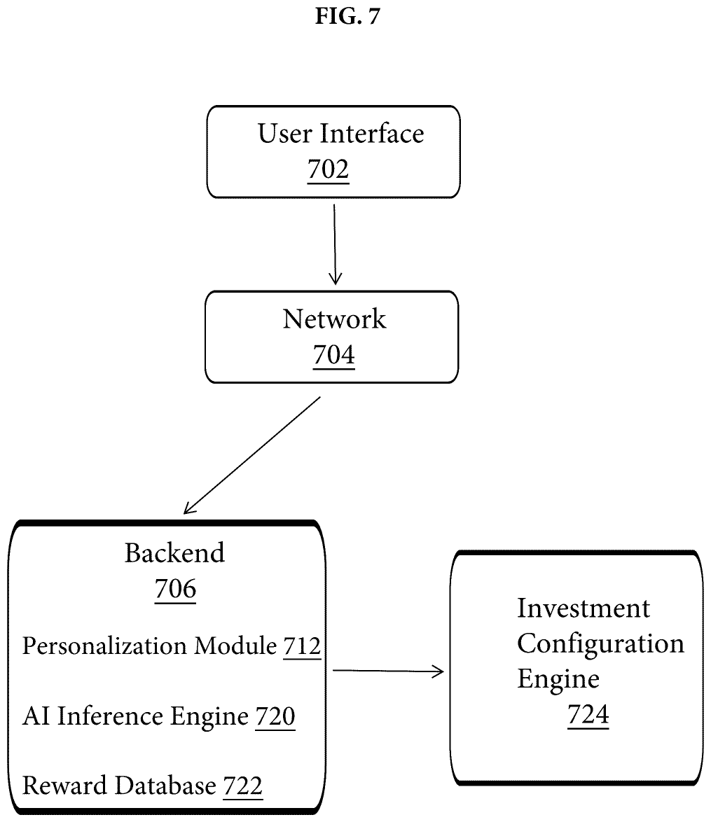

At 106, the system enters the “Personalize Your Program” phase. In this step, the platform receives company-specific inputs such as industry, number of employees, branding (e.g., logo, colors), strategic priorities, and implementation preferences. These are processed through the personalization module described in connection with FIG. 7.

The next step, 107, labeled “Choose Employee Investment Options,” is an optional but important feature that allows the employer to associate employee rewards with downstream financial tools. These options may include direct deposit to HSAs, retirement contributions, or internal savings accounts configured via the investment configuration engine.

After all modular configuration steps are complete, the combined inputs are transmitted into the Evolve Trained AI Engine, designated by 108. The AI engine processes employer selections, historical data, and predictive modeling to generate a fully formed RSA program tailored to the employer's workforce and goals. As described elsewhere, the AI engine may operate using supervised learning and inference pipelines, and it integrates all modular components into a cohesive output.

The output of the AI engine is shown at callout 109, labeled “Output from AI Engine: Detailed RSA Program plus options.” This output may include recognition-to-reward mappings, estimated engagement impact, delivery timelines, and budget analysis. The RSA output may be delivered in multiple formats, including a downloadable document, a web-based dashboard, or an API-ready configuration file suitable for integration with HRIS or payroll systems.

FIG. 1 illustrates the sequential and modular nature of the RSA configuration and generation process. It highlights how each configuration input contributes to the final output generated by the AI engine, and demonstrates the flexible yet structured design of the RSA system.

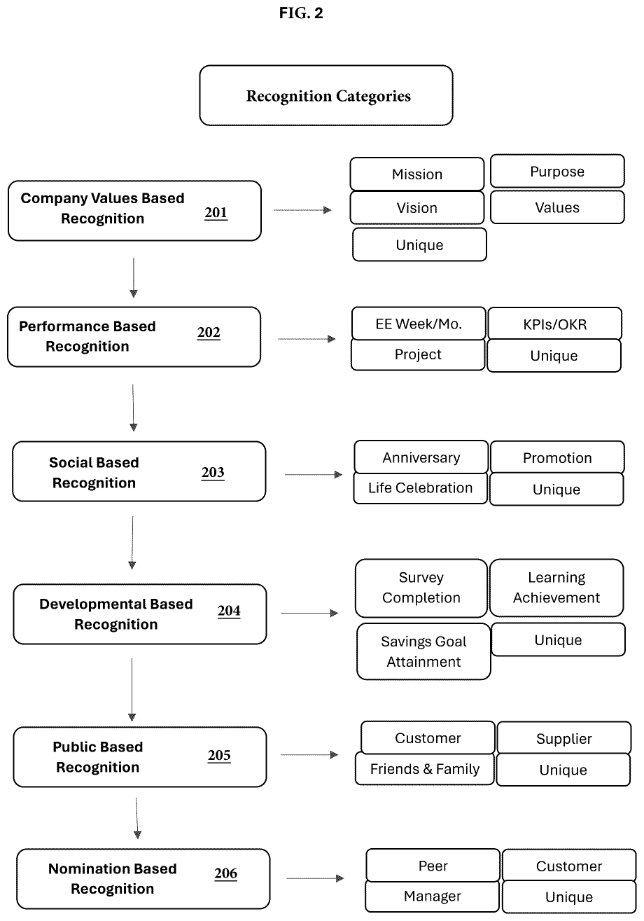

FIG. 2 provides multiple following recognition categories (RCs) useful for the RSA embodiments disclosed herein. Company Value-Based Recognition: Choose all that apply with options including company mission, vision, purpose, and multiple additional company values (e.g., integrity, focus, edge, and the like), and the option to create unique types of recognition.

Performance-Based Recognition: choose all that apply with options including any of the following: employee of the week/month/quarter/year, project work/completion, company or departmental KPIs/OKRs or other metrics, and the option to create unique performance types of recognition.

Social-Based Recognition: choose all that apply with options including any of the following: company anniversary, employee promotion, life events (e.g., pregnancy, birth, marriage, adoption, and the like), and the option to create unique social recognition types.

Developmental Based Recognition: choose all that apply with options including and of the following: learning achievement, savings or other goal attainment, completion of a private survey, plus the option to create unique performance types of recognition.

Public Based Recognition: Choose all that apply with options including the following: customers, suppliers, friends, family, plus the option to create unique performance types of recognition.

Referring again to FIG. 2, a range of recognition categories is illustrated for use within the RSA platform. At callout 201, the system presents Company Values-Based Recognition, which enables an employer to align recognition efforts with internal values such as mission, vision, purpose, and unique company ideals. Examples of such subcategories are labeled 202 and 203, including mission-specific acknowledgments and custom-defined values-based achievements.

Callout 204 illustrates Performance-Based Recognition, which includes goal-oriented metrics such as project completions, weekly or monthly KPI performance, and other quantifiable outcomes. Subcategories such as 205 include KPIs/OKRs tied to team or individual output.

Social recognition is shown at callout 203, encompassing peer-to-peer, manager-to-employee, and customer-based acknowledgments. Callout 206 represents Developmental-Based Recognition, which includes survey completions, learning milestones, and financial goal attainment. Nomination-based and public recognitions, such as customer shoutouts or employee-of-the-month programs, are also included across these categories. This modular configuration allows employers to map different recognition types to organizational values and programmatic reward logic.

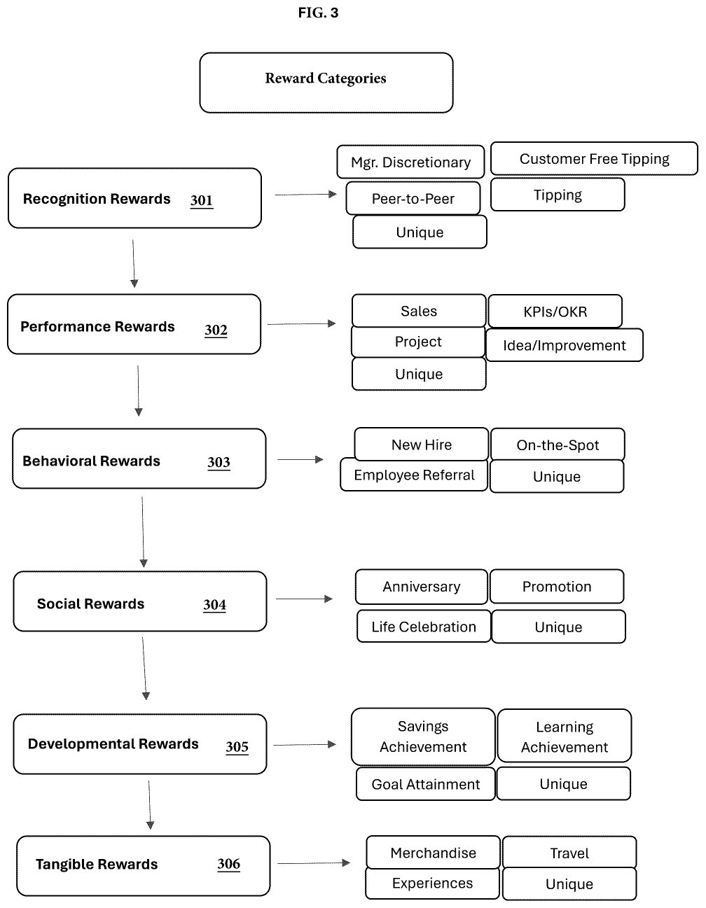

FIG. 3 provides the various reward categories available through the provided process/system showing all of the following:

Recognition Rewards: choose all that apply with options including any of the following: manager discretionary, peer-to-peer, customer free tipping where company allows customer to tip and employer pays the tip, customer monetary tipping, plus the option to create unique recognition types.

Performance Rewards: choose all that apply with options including any of the following: sales performance, project-based, KPI/OKR, Idea/Improvement Rewards, plus the option to create unique performance types.

Behavioral Rewards: choose all that apply with options including all of the following: new hire/hiring bonus, employee referral, on-the-spot, plus the option to create unique behavioral types.

Social Rewards: choose all that apply with options including all of the following: anniversary, work promotion, life celebration, and the option to create unique social types.

Developmental Rewards: choose all that apply with options including the following: savings achievement, learning achievement, goal attainment, and the option to create unique developmental types.

Tangible Rewards: choose all that apply with options including the following: merchandise, experiences, travel, and the option to create unique tangible types.

FIG. 3 further illustrates the hierarchical structure of available reward categories within the RSA platform. Callout 301 groups these categories as configurable modules. Callout 302 represents Recognition and Performance Rewards, including manager discretionary awards and tipping systems. These are often used for high-visibility, milestone-based recognition.

Callout 303 encompasses Behavioral Rewards, which incentivize activities such as employee referrals, peer acknowledgments, and customer interactions (e.g., free tipping). Callout 304 defines Developmental Rewards, used to reinforce goal achievement, learning milestones, or idea generation.

At callout 305, the system offers Tangible Rewards, such as travel experiences, branded merchandise, or celebratory packages for anniversaries or promotions. Callout 306 includes mixed or specialized reward types, including incentives tied to savings goals, employee wellness achievements, or process improvements. These categories provide a flexible reward matrix that can be algorithmically paired with recognition events during AI program generation.

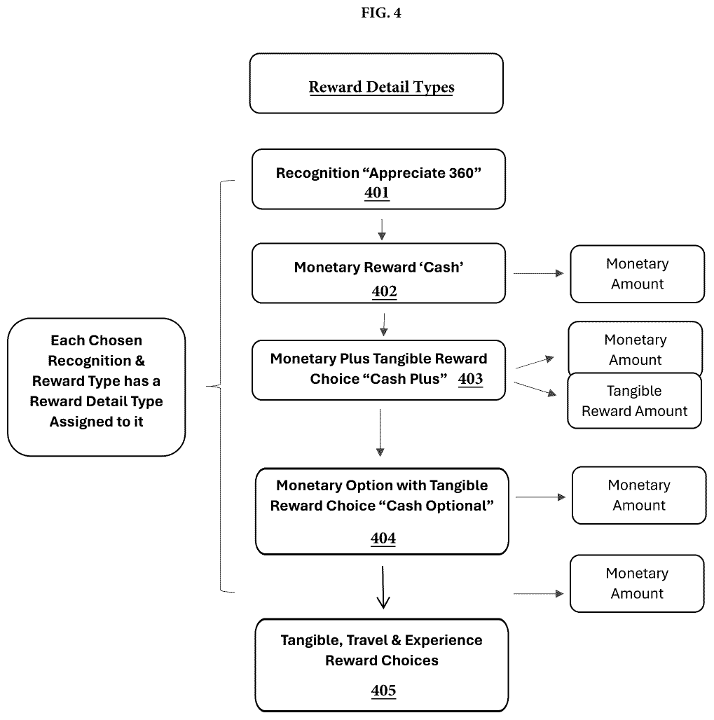

FIG. 4 provides the various reward detail types including, but not limited to, company employee recognition, monetary rewards of various type and kind, and certain tangible rewards. Examples include a) recognition via a website branded for employer that allows employees, managers, customers, suppliers, friends, family and others to recognize an employee's efforts tied to the recognition and reward categories and types; b) monetary rewards with the amount chosen by employer; c) monetary reward plus a tangible reward or “Cash Plus” (e.g., whereby employer chooses value of both monetary and tangible reward and/or employee receives the cash reward plus the choice of a tangible reward item); d) a monetary reward option alongside a choice of tangible reward options (e.g., whereby the employer chooses the monetary value of the reward and can adjust the monetary value that corresponds to the tangible reward options); e) tangible rewards inclusive of choice of merchandise, experiences, and travel reward options (e.g., whereby the employer chooses corresponding monetary value for each reward type).

FIG. 4 presents the system architecture for configuring reward detail types, which define the delivery format for each reward category. Callout 401 indicates that each recognition/reward type receives a mapped reward detail configuration.

Callout 402 denotes the “Appreciate 360” format, which represents non-monetary recognition, such as social acknowledgment, digital praise, or cultural badges. Callout 403 defines a Monetary Reward (Cash), which may be issued via payroll, gift cards, or digital transfer. Callout 404 describes the Cash Plus configuration, in which a monetary reward is bundled with a tangible item or experience. Callout 405 presents the Cash Optional mode, which allows the employee to select between a cash payout or a pre-configured tangible reward. These options are critical for aligning reward delivery with employee preferences and organizational cost models.

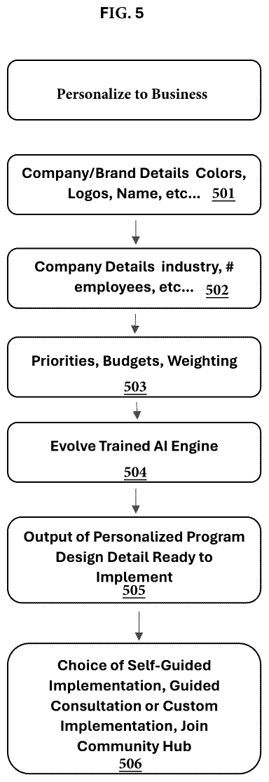

FIG. 5 provides the feature of personalization to a controlling corporation/business/employer which provides one or more options to add as much information and detail as desired. The one or more options include company name, colors, logos, industry type, number of employees, priorities with weighting, budgets, and the like. Also, utilizing the system AI engine, data and information is parsed for understanding, validated against best practices, goes through an error detection and correction process. Further, the data is normalized, standardized, and extrapolated to provide one or more recommendations and/or improvements.

FIG. 5 outlines the personalization phase of the RSA generation process. At callout 501, the platform begins customization based on the employer's unique operational and cultural profile. Callout 502 collects branding assets, including company logos, colors, and names, to ensure brand-consistent presentation across program interfaces.

Callout 503 captures structural company information, including industry, total number of employees, and operating regions. Callout 504 introduces employer-configured priorities, budget limits, and recognition weighting rules. These inputs are routed into the AI engine shown at callout 505, which generates a fully customized RSA program in real time.

At callout 506, the employer is presented with implementation options: (1) self-guided deployment via downloadable templates and instructions; (2) guided consultation, in which platform support is provided; or (3) custom rollout, a white-glove service that includes integration and training. An optional community hub allows benchmarking across peer organizations.

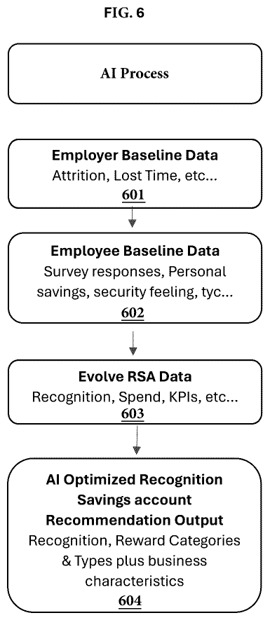

FIG. 6 provides information about the use artificial intelligence (A/I) in the processes and systems for RSA creation and use

The AI process incorporates data sources from collected employer baseline data, employee collected baseline data and compares these data points to Evolve collected data post involvement with the program and provides a recommendation.

In practice, employer baseline data is collected during the implementation process and is self-reported by employers. Examples of data collected include industry type, number of employees, attrition rates, absence rates, pay rates, reward budgets, and the like. The employee baseline data is collected during account setup and via individual surveys. Such data types include, but are not limited to, data collected includes savings level, attitudes, opinions and other financial data points. Company (i.e., system) data sets are built hereby on modeled and/or collected data. The system AI engine herein compares all data sets to produce one or more recommendations of an idealized program.

Importantly, the systems and methods herein are operated and managed on a computer system which may comprise one or more computers, server grade computers and the like.

FIG. 6 further illustrates the AI input flow used to dynamically generate and refine RSA configurations. Callout 601 represents Employer Baseline Data, such as historical attrition, absenteeism, employee tenure, and cost-per-hire metrics. Callout 602 captures Employee Baseline Data, including individual survey responses, self-reported financial wellness indicators, and engagement sentiment.

Callout 603 refers to RSA Platform Data, drawn from prior program usage, redemption rates, reward costs, and performance-linked KPIs. These three input layers are used by the AI engine to generate an Optimized RSA Program, depicted at callout 604. The AI output includes recognition categories, reward pairings, delivery pathways, and estimated effectiveness, based on pattern recognition and predictive modeling.

Referring now to FIG. 7, an exemplary system architecture for implementing the Recognition Savings Account (RSA) platform is shown. The system comprises a user interface layer (UI layer) accessible by HR administrators or employees via user devices, such as smartphones, tablets, or desktop computers. These devices communicate via a network with a cloud-hosted backend engine, which comprises a personalization engine, AI inference engine, and a database cluster for storage and retrieval of employee data, company parameters, and RSA configurations.

The personalization engine performs initial configuration tasks such as collecting employer industry, values, size, budget, and employee segmentation data. These parameters are passed into the AI inference engine, which includes one or more trained machine learning models that perform pattern matching, prediction, and dynamic customization of reward programs.

The user interface layer provides front-end access to the RSA system for HR administrators and employees. It supports entry of employer-specific data, such as company values, employee demographics, recognition priorities, and budget constraints. This interface may be implemented as a web application or mobile app and enables users to view, configure, and deploy RSA programs.

The network layer connects the user interface to backend servers via a secured communication protocol, such as HTTPS. It facilitates the secure transmission of user data, RSA configuration parameters, and reward history between client devices and the server-side logic.

The backend layer houses the core functional modules of the RSA system. These include: a) A personalization module, configured to analyze employer inputs (e.g., values, branding, and priorities) and generate an initial RSA configuration tailored to that employer; b) An AI inference engine, which receives structured input from the personalization module and other data sources (including historical RSA usage metrics) and generates a dynamic, optimized RSA program using one or more trained machine learning models; and c) A reward database, which stores available recognition types, reward structures, and corresponding monetary or tangible values. It also logs historical reward redemptions and engagement metrics.

Additionally, the backend is connected to an investment configuration engine. This module facilitates the integration of financial incentive components into the RSA system. It enables employers to associate reward redemptions with external financial institutions, such as 401(k) contributions, HSAs, or custom savings instruments. The investment configuration engine can be API-integrated with third-party financial platforms.

Together, these layers enable a seamless end-to-end recognition, reward, and investment platform. The architecture supports real-time RSA program generation and updates, while providing extensibility through its modular backend design.

The AI engine is composed of a data preprocessing module, a feature extractor, a trained model engine (e.g., XGBOOST® or neural network), and a recommendation generator. The AI engine outputs an RSA program structure including recommended recognition types, reward mappings, investment pathways, and deployment format based on employer goals and historical data.

Referring now again to FIG. 7, the system architecture of the RSA platform is shown as a layered, modular computing environment. Callout 702 represents the User Interface, a front-end platform used by employers and employees to access and interact with the RSA system.

Callout 704 denotes the Network Layer, which enables encrypted communication between user devices and server-side systems. The Backend, shown at callout 706, houses the platform's core logic and database infrastructure. Within the backend, callout 712 identifies the Personalization Module, which processes employer-specific inputs for branding, values, and configuration logic.

Callout 720 is the AI Inference Engine, responsible for processing structured inputs and generating RSA recommendations. The Reward Database at callout 722 stores all reward types, redemptions, and associated metadata. Callout 724 represents the optional Investment Configuration Engine, which links the reward logic to financial instruments (e.g., 401(k), HSAs) based on employee preferences and employer integration settings.

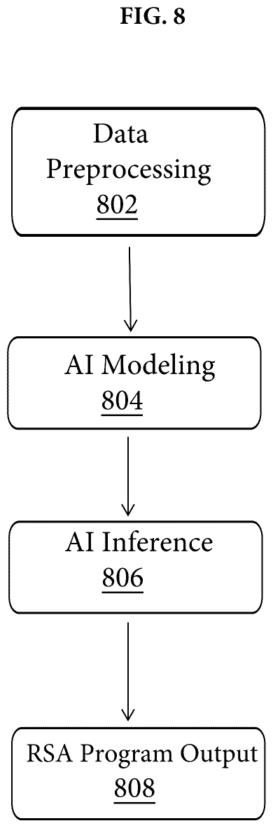

FIG. 8 illustrates the AI data flow. The engine receives data inputs from three primary sources: (1) employer baseline data (e.g., attrition rates, absence, KPIs); (2) employee baseline data (e.g., savings habits, survey responses); and (3) RSA usage data (e.g., savings history, engagement metrics). This data is normalized, and features are extracted for training or inference. Inference results are used to select or weight RSA elements (e.g., reward tier types, delivery methods), and are refined through feedback loops with updated performance metrics.

In general, the process begins with data preprocessing. This module receives heterogeneous data inputs that include the following: a) employer-provided organizational metrics (e.g., attrition, absence, revenue per employee); b) employee-level data (e.g., survey responses, participation rates, savings goals); and c) historical RSA usage metrics (e.g., redemption frequency, satisfaction ratings).

In practice, the preprocessing module cleans, normalizes, and encodes this data to conform to the required input format for the AI modeling system. Preprocessed data flows into the AI modeling module. This component includes one or more trained machine learning models, such as gradient boosting trees, neural networks, or ensemble classifiers. These models were trained on labeled RSA program data and are optimized to predict the most effective recognition-reward pairings; reward structures that maximize employee engagement; and budget-efficient reward delivery pathways.

The AI then proceeds to the inference stage, where the trained models are applied to the specific input data of the employer. The model generates one or more program configurations tailored to the employer's workforce characteristics and stated goals.

The resulting RSA program is generated and formatted at the RSA program output module. This output includes a complete set of a) recognition categories and recommended reward types; b) estimated program impact metrics (e.g., predicted engagement lift, cost efficiency); and c) structured output for rendering via dashboard or document format. In turn, a feedback loop connects the RSA program output back to the preprocessing module. As new usage data is collected-such as redemption rates, updated employee survey responses, or financial outcomes-the AI engine retrains or recalibrates its internal models. This allows the RSA system to evolve dynamically and increase its accuracy and utility over time.

The machine learning engine supports supervised and unsupervised learning modes. During supervised training, labeled data from successful RSA implementations are used to generate accurate reward mappings. In live environments, the engine operates in inference mode to generate program recommendations in real time.

FIG. 8 details the internal pipeline of the AI engine used to infer and generate RSA programs. Callout 802 represents the Data Preprocessing module, which handles normalization, feature extraction, and formatting of employer and employee data prior to model ingestion.

Callout 804 is the AI Modeling component, where trained machine learning models-such as decision trees, regression networks, or ensemble classifiers-operate on the preprocessed data. Callout 806 represents the AI Inference module, which applies current model weights to incoming data in real time to produce RSA configuration outputs.

The final output, shown at callout 808, is formatted RSA program data that includes recommended recognition and reward pairings, delivery modes, and investment options. This output is rendered for use in both human-readable and machine-readable formats and may be adapted based on implementation type.

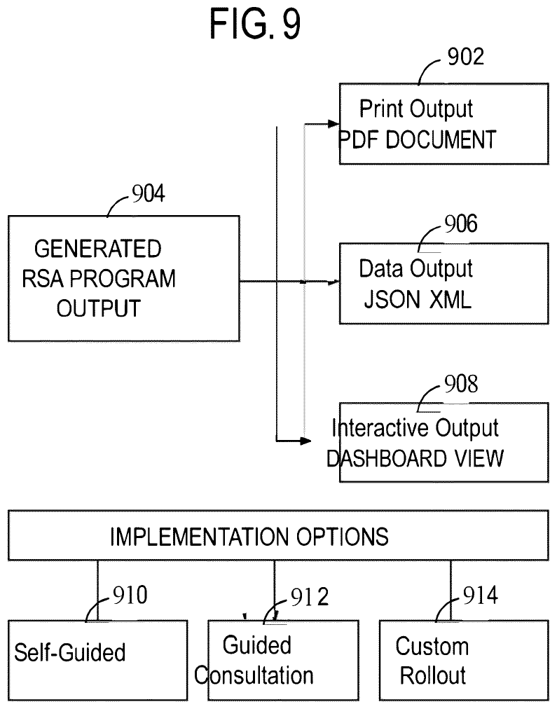

FIG. 9 shows the structure of a generated RSA program output. The AI engine generates a plan that includes a list of recognition categories, reward tiers, mapped investment options, and implementation options. The output may be provided as a formatted document (e.g., PDF), structured data (e.g., JSON or XML), or integrated into a software dashboard via web interface. It also includes optional guidance for implementation: self-guided, consultation-based, or fully managed deployment.

The RSA platform includes an output module that formats the plan into visual or printable components, customizable by the employer. Employees may access their assigned rewards, financial tools, and progress dashboards via secure login. Authentication protocols and data protection are managed through standard TLS/SSL encryption and multi-factor authentication support.

FIG. 9 depicts the system's RSA program output modalities and supported implementation pathways. Callout 902 denotes the Generated RSA Program Output, a fully configured and personalized recognition and reward structure generated by the AI engine.

Callout 904 represents the Print Output option, which may take the form of formatted PDF documents. Callout 906 refers to the Data Output, including JSON and XML files suitable for API-based or system-to-system integration. Callout 908 illustrates the Interactive Dashboard View, allowing employers and employees to manage, track, and modify RSA activity in real time via a web interface.

Callout 910 introduces the Implementation Options framework. Callout 912 corresponds to Self-Guided Implementation, in which employers deploy the program using RSA platform templates and support materials. Callout 914 includes Guided Consultation or Custom Rollout, which may involve direct support from RSA service providers or system integrators.

### Example I

A 250-employee software development company implements the RSA system to increase retention and morale during a period of rapid growth. The HR director accesses the RSA platform via a web interface and inputs company data including employee count, turnover rate, compensation data, and the company's core values: innovation, accountability, and collaboration.

The personalization engine configures the initial RSA structure, and the AI engine uses pretrained models to analyze the company's attrition patterns, existing internal survey data, and KPIs related to product cycle efficiency. Based on these inputs, the AI engine recommends the following: a) company values-based recognition with peer-to-peer nomination; b) monthly performance-based rewards for code quality improvements; and c) developmental rewards for completion of technical certifications.

The system outputs a complete RSA program in PDF and JSON formats. The program includes an annual reward budget allocation, a tiered recognition schema, integration instructions for the company's HRIS system, and suggestions for investment accounts with a fintech partner API. Implementation proceeds via the “guided consultation” option.

### Example II

A 30-location retail franchise with 1,200 employees implements the RSA system across its network to address high employee turnover and inconsistent store performance. Store managers provide localized data on absenteeism, sales performance, and customer satisfaction. The central HR office uploads employer baseline data and brand values: respect, hustle, and teamwork.

The AI engine processes this data using a federated model that learns from high-and low-performing locations. It recommends a tiered RSA deployment that includes the following: a) behavioral rewards for perfect attendance; b) public recognition via customer-initiated rewards using in-store tablets; c) tangible rewards (merchandise+travel) for top-performing locations; and d) social rewards for birthdays, work anniversaries, and employee referrals.

The system outputs a master RSA deployment plan tailored by location, with recommendations for monetary and non-monetary reward ratios, store-specific implementation templates, and a shared metrics dashboard for executive review. Franchisees receive access via mobile admin apps and implement the program through the “custom implementation” path.

In both examples, the RSA system dynamically adapts to organizational scale, data granularity, and reward culture by utilizing modular AI components and cloud-deployed analytics pipelines. The result is a personalized, scalable employee recognition and benefit framework optimized for measurable workplace outcomes.

Any mention of specific brand names, manufacturers, or model numbers (including, but not limited to, microprocessors, graphics processing units, sensors, memory modules, and connectivity hardware) is provided solely for illustrative purposes. Such references are exemplary of the types of hardware components intended to be used in implementing the present invention and are not intended to limit the scope of the invention to any specific brand, model, or manufacturer. Persons of skill in the art will readily recognize that equivalent components, whether now known or later developed, that perform substantially the same function in substantially the same way with substantially the same result are within the scope of this disclosure and the appended claims.

This written description uses examples to disclose the invention, including the best mode, and to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented Recognition Savings Account (RSA) system for employee benefits, comprising:
a. a user interface layer configured to receive input from an employer regarding company-specific values, workforce demographics, and organizational priorities;
b. a reward module configured to enable selection of employee reward categories;
c. a recognition module configured to enable selection of employee recognition categories;
d. a reward detail module configured to customize reward types for each recognition and reward category;
e. a personalization engine configured to incorporate company-specific branding, budget data, and implementation preferences;
f. an AI inference engine configured to receive structured input from said modules and process employer baseline data, employee baseline data, and RSA system data to generate an optimized RSA program;
g. a backend output module configured to deliver the RSA program via a digital dashboard, PDF document, or data export; and
h. a communication interface configured to transmit program recommendations to employee-facing portals or external HR systems.

2. The system of claim 1, wherein the employee reward categories include:
a. performance rewards;
b. behavioral rewards;
c. developmental rewards; and
d. tangible rewards.

3. The system of claim 1, wherein the employee recognition categories include:
a. company values-based recognition;
b. performance-based recognition;
c. social-based recognition;
d. public-based recognition; and
e. nomination-based recognition.

4. The system of claim 1, wherein the personalization module further comprises:
a. means for incorporating company-specific colors, logos, and names; and
b. means for including company details such as industry type, number of employees, and organizational priorities.

5. The system of claim 1, wherein the trained AI engine utilizes input data comprising:
a. employer baseline data, including attrition rates and lost time;
b. employee baseline data, including survey responses, personal savings, and security feelings; and
c. RSA-specific data, including recognition activities, spend, and key performance indicators (KPIs).

6. The system of claim 2, wherein the performance rewards include:
a. manager discretionary rewards;
b. peer-to-peer rewards;
c. customer-based rewards; and
d. sales and project-based rewards.

7. The system of claim 2, wherein the behavioral rewards include:
a. social rewards;
b. life celebration rewards; and
c. unique event-based rewards.

8. The system of claim 2, wherein the developmental rewards include:
a. learning achievement rewards;
b. savings goal attainment rewards; and
c. idea and improvement rewards.

9. The system of claim 2, wherein the tangible rewards include:
a. merchandise rewards;
b. travel rewards; and
c. experiential rewards.

10. The system of claim 1, wherein the module for detailing reward types includes:
a. options for monetary rewards;
b. options for tangible rewards; and
c. options for a combination of monetary and tangible rewards.

11. The system of claim 1, further comprising an output module configured to generate a personalized RSA program design, ready for implementation, with options for self-guided implementation, guided consultation, or custom implementation.

12. The system of claim 1, wherein the AI engine's output includes:
a. recommendations for recognition and reward categories and types;
b. recommendations based on business characteristics and employee demographics.

13. The system of claim 1, wherein the module for selecting employee investment options includes:
a. options for different financial institutions;
b. options for various investment vehicles tailored to employee preferences.

14. The system of claim 1, further comprising a collaborative analytics platform enabling employers to share anonymized RSA configuration data, benchmark results, and receive AI-enhanced comparative feedback based on similar organizational profiles.

15. The system of claim 1, wherein the AI inference engine uses a supervised neural network trained on labeled RSA performance data.

16. The system of claim 1, wherein the reward module enables custom reward templates based on employer industry and company size.

17. The system of claim 1, wherein the recognition module restricts category customization to a pre-approved list defined by company HR personnel.

18. The system of claim 1, further comprising a confidence scoring system for AI-generated recommendations, calculated from historical participation rates and reward redemptions.

19. A method for generating a Recognition Savings Account (RSA) program using an AI-driven computing system, comprising:
a. receiving employer input data including recognition preferences, reward budgets, employee demographics, and business performance metrics;
b. receiving employee-specific data including financial wellness indicators, participation levels, and recognition history;
c. normalizing and preprocessing said data into a structured machine-readable format;
d. applying a trained machine learning model to identify optimal recognition categories and reward pairings;
e. generating a tiered RSA program including recognition triggers, reward types, and investment options based on inferred results;
f. formatting the RSA program for output via a digital dashboard, downloadable file, or third-party software integration;
g. storing program configuration data in a secure database; and
h. updating the program recommendations dynamically in response to periodic data refreshes or employer customization.

20. The method of claim 15, further comprising categorizing recognition into at least one of: values-based, performance-based, social-based, public-based, or nomination-based recognition types.

21. The method of claim 15, wherein reward categories include at least one of: performance rewards, behavioral rewards, developmental rewards, or tangible rewards.

22. The method of claim 15, wherein the machine learning model comprises a supervised neural network trained on labeled RSA deployment outcomes.

23. The method of claim 15, wherein employee-specific data is obtained through digital surveys and tracked participation in prior employer-sponsored programs.

24. The method of claim 15, further comprising mapping recognition events to monetary and non-monetary reward options using a customizable rules engine.

25. The method of claim 2, further comprising presenting implementation options selected from: self-guided rollout, guided consultation, or custom deployment plan.

26. The method of claim 15, wherein the RSA program output includes structured metadata tags configured for export to a human resource information system (HRIS) or payroll platform.

27. The method of claim 15, further comprising calculating recognition impact metrics including employee engagement rates, program utilization rates, and redemption frequency.

28. The method of claim 15, further comprising allowing employers to personalize program branding, color schemes, and user interface elements within the RSA output.

29. The method of claim 15, wherein the formatted output includes a downloadable PDF document and an interactive dashboard rendered using web-based markup and visualization tools.

30. The method of claim 15, wherein updates to the RSA program are triggered by threshold changes in employee feedback scores or business key performance indicators (KPIs).

31. The method of claim 15, wherein the secure storage of program configurations and employee data complies with encryption standards and access control protocols including TLS and multi-factor authentication.
